(19) United States
(12) Patent Application Publication
(10) Pub. No.: US 2025/0322685 A1
(43) Pub. Date: Oct. 16, 2025

(54) SYSTEM AND METHOD FOR PERFORMING OPTICAL CHARACTER RECOGNITION ON DOCUMENTS AND FOR SEARCHING DOCUMENTS

(71) Applicant: Kyocera Document Solutions Inc., Osaka (JP)

(72) Inventor: Ralph Bryan Baria FUERTE, Wayne, NJ (US)

(73) Assignee: Kyocera Document Solutions Inc., Osaka (JP)

(21) Appl. No.: 18/636,809

(22) Filed: Apr. 16, 2024

(51) Int. Cl. G06V 30/418; G06F 16/33

(52) U.S. Cl. CPC G06V 30/418; G06F 16/3337

(57) ABSTRACT

A document management system including an OCR (optical character recognition) performing module and a document searching module is disclosed. The document management system is a cloud archiving and indexing system that translate uploaded documents to user-selected language versions and performs OCR on the user-selected language versions to generate searchable PDF documents. Each translated word of the different language versions is indexed to indicate its multilingual meanings, its multidialectal use, its synonymous words, its different character sets ad phonetic adaptations, and so on. The indexing can be used to link to the different language versions while conducting a document search, so as to improve the searching flexibilities.

### FIELD OF THE INVENTION

The present invention relates to systems and methods for performing optical character recognition (OCR) on documents to improve searching result on multi-lingual documents.

### DESCRIPTION OF THE RELATED ART

While searching a document, a user enters at least one keyword to search documents containing at least the one keyword. Currently, an uploaded document may be translated into different language versions. The user can select the language of a document he/she wishes to see. For example, if a user enters a keyword “école,” which is a French word meaning a school in English, the user will retrieve documents containing this word “école,” but not documents containing “school.” Therefore, there is a need to improve the search result by considering other factors, such as multilingual meanings, multidialectal meanings, etc.

### SUMMARY OF THE INVENTION

A computer-implemented method for searching documents in a variety of languages is disclosed. The method includes translating the documents in selected languages to generate multi-language versions and indexing every translated word of the multi-language versions based on predetermined criteria. Every translated word is embedded with an index, and there are plural types of indexes in each of the multi-language versions. The method further includes entering a keyword and searching criteria for searching, using the keyword and the searching criteria to search the documents, wherein the searching criteria are associated with certain types of indexes of the multi-language versions, searching related documents based on the certain type of indexes, and if the keyword and any of the indexed translated words of the multi-language versions match, outputting the matched multi-language version as search results.

The computer-implemented method further comprises performing an optical character recognition (OCR) on the multi-language versions before searching. The OCR performance generates searchable PDF documents and the plural types of indexes are embedded in the searchable PDF documents. The method searches the searchable PDF documents based on the keywords and searching criteria.

The searching criteria in accordance with the disclosed embodiments includes searching documents in at least one specific language, and wherein the translating is performed after the at least one specific language is selected.

The plural types of indexes include indexes associated with a multilingual meaning, a multidialectal use, different character sets and phonetic adaptions, and synonymous words of every translated word of the multi-language versions. Further, the indexing includes indexing error-spelling words in an original document and their correct-spelling words and correlating the error-spelling words and the correct-spelling words. Moreover, the method generates a summarized version of the document when a length thereof is longer than a predetermined number of words or pages, and saving the summarized version of the document.

Another embodiment of a computer-implemented method for searching documents saved in a variety of language is disclosed. According to the disclosed embodiments, the method comprises receiving a keyword entered by a user using a first language, receiving searching criteria including searching a document in a second-language version, translating original documents into the first and second languages and storing a first language version, a second language versions, and the original documents in a database, wherein the first and second language versions are linked to the original documents, indexing each translated word of the first and second language versions. Each translated word of the first and second language versions is embedded with an index, and there are plural types of indexes in each of the first and second language versions. The method further comprises using the keyword and the searching criteria to search the documents, wherein the searching criteria are associated with certain types of indexes of the first and second language versions, searching related documents based on the certain type of indexes, and if the keyword and any of the indexed translated words of the first and second versions match, outputting the matched multi-language version as search results.

The above-mentioned method further comprising performing an optical character recognition (OCR) on the first and second language versions before searching, wherein the OCR performance generates searchable PDF documents, wherein the plural types of indexes are embedded in the searchable PDF documents, and wherein the searching is to search the searchable PDF documents. The searching criteria includes different searching combination that are selectable by the user.

A search system for searching a document in a specific language is further disclosed. According to the disclosed embodiments, the search system includes a user interface interacted with a user to enter instructions and select searching criteria and a computer, including a processor, a database, and a display. The database stores computer-readable instructions, that when executed, causes the processor to perform translating an original document into different language versions and storing the different language versions and the original documents in a database, wherein the different language versions are linked to the original documents, indexing each translated words of the original document based on predetermined criteria, wherein each translated word of the different language versions is embedded with an index, and there are plural types of indexes in each of the first and second language versions, performing an optical character recognition (OCR) on the different language versions to generate searchable PDF documents, wherein the searchable PDF documents includes the indexes embedded in the different language versions, receiving a keyword entered by the user using a first language, receiving searching instructions including search documents in a second-language version, using the keyword and the searching instructions to search among the searchable PDF documents, wherein the searching instructions are associated with certain types of indexes, searching related documents based on the certain type of indexes; and if the keyword and any of the indexes of the searchable PDF documents match, outputting the matched searchable PDF documents as search results.

The plural types of indexes include indexes associated with a multilingual meaning, a multidialectal use, different character sets and phonetic adaptions, and synonymous words of every translated word of the multi-language versions. The indexing includes indexing error-spelling words in an original document and their correct-spelling words and correlating the error-spelling words and the correct-spelling words. Also, a matched searchable PDF document is longer than a predetermined number of words or pages, displaying the match searchable PDF document in a summarized version.

### BRIEF DESCRIPTION OF THE DRAWINGS

Various other features and attendant advantages of the present invention will be more fully appreciated when considered in conjunction with the accompanying drawings.

FIG. 1 illustrates a block diagram of a document management system according to the disclosed embodiments.

FIG. 2 illustrates a block diagram of an OCR performing system according to the disclosed embodiments; the OCR performing system is a part of the document management system of FIG. 1.

FIG. 3 illustrates a block diagram of an OCR device according to the disclosed embodiments.

FIG. 4 illustrates an index table indicating different type of indexes used according to the disclosed embodiments.

FIG. 5 illustrates a block diagram of a document searching system according to the disclosed embodiment; the document searching system is a part of the document management system of FIG. 1.

FIG. 6 illustrates a flowchart for performing an OCR on documents according to the disclosed embodiments.

FIG. 7 illustrates a flowchart 700 for searching documents according to the disclosed embodiments.

FIG. 8 illustrates a flowchart 800 for searching documents according to alternative disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims. Numerous specific details are set forth in order to provide a thorough understanding of the present invention.

The preferred embodiments of the present invention enhance flexibilities of searching documents electronically. In accordance with the disclosed embodiments, uploaded documents may be translated into different languages while performing an OCR (optical character recognition) on the documents. Words in the different-language versions are indexed based on their multidialectal uses, different character sets and phonetic adaptions, similar meanings or close association, transliterated meanings and so on. The indexing will be used in searching documents with selected languages for more flexible and accurate results.

Thus, the disclosed embodiments allow users to choose which language versions they want to search even though they do not know the language. For example, users who do not know French can enter keywords like “school” to search documents in French language. As “école” means “school” in French, documents containing “école” will be chosen. Further, based on dialects used in different English-speaking or Spanish-speaking countries, the users may also obtain documents containing multidialectal words. For example, when searching documents containing the word “elevator” (US-English), documents containing the word “lift” (UK-English) may also be found. Similarly, in accordance with the preferred embodiments, incorrect spellings detected in the documents while preforming the OCR can also be indexed together with their correct spellings. Therefore, when searching documents containing word “phlem” which is mis-spelled, a search engine may find documents containing a correct-spelling word “phlegm.” Moreover, if a document is more than a predetermined number of words, e.g., 500 words or more than one page, the document could be displayed in a search result as a summarized version in the user's selected language/dialect. The preferred embodiments of the present invention may also be intelligent enough to deliver search results that are related to the context of the user's recent search history. For example, an employee who works for a construction company searches for “CAT” may receive results for “CAT” brand construction equipment and not the animal.

The preferred embodiments of the present invention relate to document management and document searching, which mainly include two parts: OCR performing and document searching. The OCR performing may be done when the documents are uploaded to a document management system of the preferred embodiments. The OCR performing may be done at a printing device, such as a multi-function printing device, when a document is scanned. The OCR performing may also be done at a computing device for documents saved in a database associated with the computing device. During the OCR performing, the documents may be translated into different languages and each word is indexed based on its characteristic features, such as its multidialectal, transliterated, synonymous, copyedited meanings. The document searching uses the indexing to identify documents that match searching criteria chosen by a user.

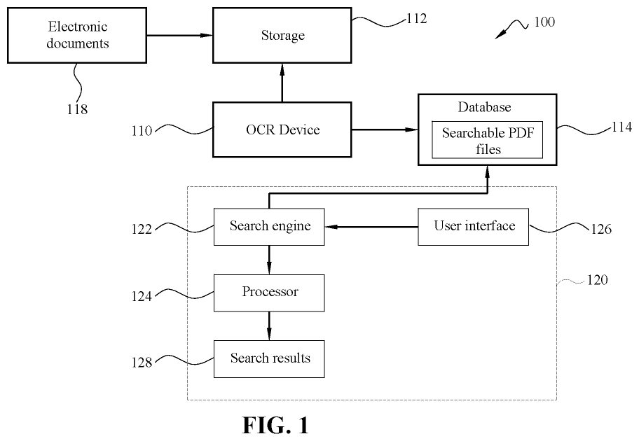

FIG. 1 illustrates a block diagram of a document management system 100 in accordance with the disclosed embodiments. As described above, document management system 100 includes an OCR device 110 and a document searching device 120. OCR device 110 performs OCR on documents uploaded to the system or stored in a storage 112 to become searchable PDF documents. Searching device 120 receives searching selection from a user interface 126 to search among the searchable PDF documents.

Document management system 100 includes a storage 112 that stores uploaded or scanned documents 118 from a computing device or a printing device such as an MFP (not shown in FIG. 1.) OCR device 110 performs OCR on each of document 118. In accordance with the disclosed embodiments, while OCR device 110 not only performs OCR on documents 118 but it also process documents to be searchable PDF documents. The searchable documents are then stored back to storage 112 or in a separate database 116. In some embodiments, the original document 118 is stored in storage 112 and the searchable PDF documents is stored in database 116, so storage 112 may be accessed by a third party who likes to view in the original date format.

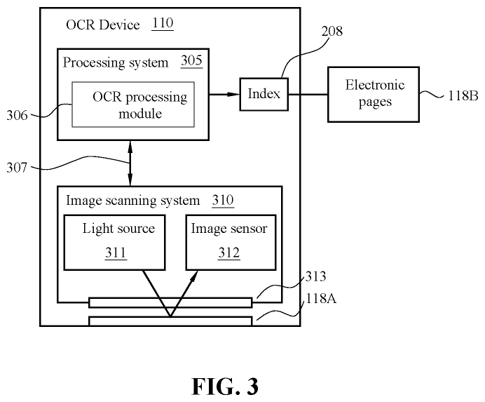

OCR device 110 is communicatively coupled to storage 112 within system 100. OCR device 106 may be connected to storage system 112 over a network (not shown). OCR device 106 may be within a printing device, a scanner, a computing device, and the like. OCR device 106 is disclosed in greater detail below by FIG. 3.

Searching device 120 includes a user interface 126 receiving searching instructions from a user, a search engine 122 that is capable of searching the searchable documents stored in database 114 based on the searching instructions, and a processor 124 for comparing and recognizing documents matching with the searching instructions. The searching instructions may comprise one or more selection of searching a specific language or languages, multilingual meanings, synonymous meanings, multidialectal meanings, and/or transliterated meanings of one or more words contained in documents. These instructions are selectable and can be prioritized by a user through user interface 126. A search result 128 is output and displayed to a user.

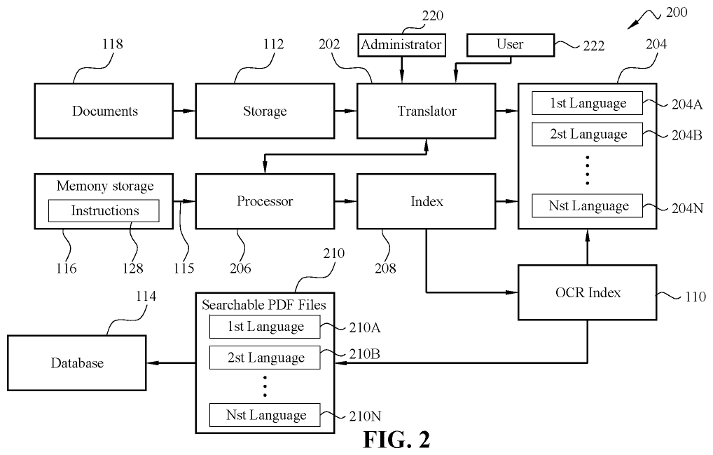

FIG. 2 illustrates a block diagram of OCR performing system 200 in accordance with the disclosed embodiments. OCR performing system 200 is a part of document managing system 100. OCR performing system 200 may be considered as a pre-processing system that operates OCR on uploaded original documents before they can be searched and edited by users.

In the embodiment of FIG. 2, electronic documents 118 are loaded and saved in database 112. When system 200 performs OCR on documents, translator 202 translates each of the electronic document 118 into multi-language versions 204 including first-language version 204A, second-language version 204B, . . . , and nth-language version 204N. These language versions 204A, 204B, . . . , 204N are then processed with OCR device 110 for OCR performances. The translated language versions are selected and configured by a system administrator 220 of document management system 100 or a user 222 when conducting a document search.

OCR performing system 200 includes a processor 206 that executes instructions 128 stored in a memory storage 116 to configure the system 200 to perform specified functions. Processor 206 is connected to memory storage 116 by data bus 115. One specified function performed by processor 206 is to add indexes 208 to each translated word of the number of language versions 204A, 204B, . . . , 204N based on their characteristics. Such characteristics include its multilingual meanings, its multidialectal use, its different character sets and phonetic adaptions, its synonymous words (i.e., similar meaning or close association thereof,) and so on. In the disclosed embodiments, document originals with spelling errors still get indexed in both the correct and incorrect spelling of words. This would include any word that should have special characters (for example, missing accented letters.) Based on the indexes 208, the words in different languages with same or similar lingual meanings, dialectic uses, different character sets and phonetic adaption, synonymous meanings or misspelling errors are able to associate with each other. The indexes 208 will be used in a document searching process to facilitate the flexibility and efficiency of searching.

Another specified function performed by processor 206 is to generate and translate a summarized document for a document longer than a pre-determined number of words, for example, 500 words, or more than one page (for example). This summarized-version document will be displayed to a user in search results in the user's selected language/dialect.

According to the disclosed embodiments, to improve performance and reduce cost, OCR performing system 200 can be configured to perform translation services of only user-selected languages during a document searching process, or offer a wider language-compatibility pack as an upsell. Further, although translator 202 is shown as a separate element in FIG. 2, translation could be done by processor 206 when executing instructions 128 stored in memory storage 116.

After the multi-language versions 204 are generated, OCR device 110 performs OCR on each of the multi-language versions 204 and generates searchable PDF documents 210 of the multi-language versions including first language PDF document 210A, second language PDF document 210B, . . . , and nth language PDF document 210N. These searchable PDF documents 210 are then saved in database 114. These searchable PDF documents 210 may also be saved in storage 112. Each of the searchable PDF documents 210 is embodied with indexes 208. Indexes 208 may include attributes, metadata, etc. that facilitate fast retrieval of documents.

FIG. 3 depicts OCR device 110 according to the disclosed embodiments, in which OCR device 110 is within a printing device or a scanning device. In FIG. 3, OCR performance is executed when a document is scanned. OCR device 110 receives a page or document 118A. Further pages may be loaded after processing of page 118A is complete. OCR device 110 includes an image scanning system 310 communicatively coupled to a processing system 305 via a communications link 307. Communications link 307 may be a wire, a communications cable, a wireless link, or a metal track on a printed circuit board.

Image scanning system 310 includes a light source 311 that projects light 320 through a transparent window 313 to strike a surface of page 118A. Page 118A, which may be a sheet of paper containing text or graphics, reflects light 322 towards an image sensor 312. Image sensor 312 contains light sensing elements, such as photodiodes or photocells, converts received light 322 into electrical signals that are transmitted to OCR processing module 306 within processing system 305. The electrical signals may be digital bits.

Processing system 305 generates electronic page 118B from the captured data for page 118A. Electronic page 118B is a searchable PDF page. Electronic page 118A is included in one of the electronic documents. In some embodiments, OCR device 110 is a slot scanner incorporating a linear array of photocells. OCR processing module 306 that is a part of processing system 305 may be used to operate upon the electrical signals for performing optical character recognition of text and graphics printed on page 118A.

OCR processing module 306 may also embed indexes 208 detected in the scanned electronic page 118A to electronic page 118B. According to the disclosed embodiments, electronic page 118B is a form of searchable PDF page with embedded indexes 208.

OCR device 110 in accordance with the disclosed embodiments may be within a computing device. In this embodiment, image scanning system 310 is not needed and OCR device 110 may be an App installed in the computing system. Take the OCR performing system 200 of FIG. 2 as an example, OCR device 110 may be replaced by processor 206 that executes instructions stored in memory storage 116 to perform OCR on images and texts contained in electronic documents 118 that are stored in storage 112 and to generate searchable PDF files 210 of the electronic documents 118. One embodiment is to translate the electronic documents 118 into multi-language versions 204 before the OCR is performed. In this instance, the translated languages are selected by an administrator 220 of the OCR performing system 200. However, when there are a large number of electronic documents, the multi-language versions 204 will take a lot of storage space and increase the storage cost. Therefore, another embodiment is to translate the documents 118 to only user-selected languages and to perform OCR on only the user-selected language versions when conducting the document searching.

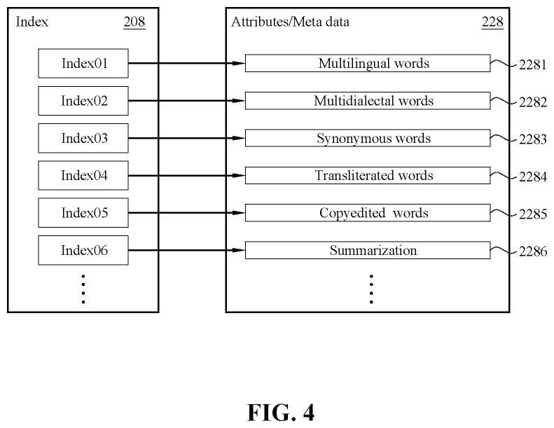

FIG. 4 illustrates exemplary indexes 208 used in multi-language versions 204 and searchable PDF files 210 generated after the OCR processing. Indexes 208 may be presented as attributes or metadata 228. Indexes 208 may include, but not limited to, Index 1, Index 2, Index 3, Index 4, Index 5, and Index N. Attributes or metadata 228 may include, but not limited to, multilingual words 2281, multidialectal words 2282, synonymous words 2283, transliterated words 2284, copyedited words 2285, and summarization page 2286. Index 1, Index 2, Index 3, Index 4, Index 5, and Index 6 are associated with multilingual words 2281, multidialectal words 2282, synonymous words 2283, transliterated words 2284, copyedited words 2285, and summarization page 2286, respectively.

That is, the disclosed embodiments index the translated documents in the following manners. It is noted that the indexing according the disclosed embodiments are not limited to the following indexing only.

Multilingual indexing: When the documents 118 are translated into different-language versions 204, every word in the document in any of selected languages should be translated and indexed.

Multilingual indexing: Multidialectal user of every translated word should be indexed;

Transliterated indexing: Every translated word should also be indexed in different character sets and phonetic adaptions;

Synonymous indexing: Every translated word should be indexed for searches of words of similar meaning or close association;

Copyedited indexing: Document originals with spelling errors still get indexed in both the correct and incorrect spelling of words. This would include any word that should have special characters (for example, missing accented letter); and

Summarization indexing: In the event that a document is longer than 500 words, then a document is displayed in search results as a summarized version in the user's selected language/dialect.

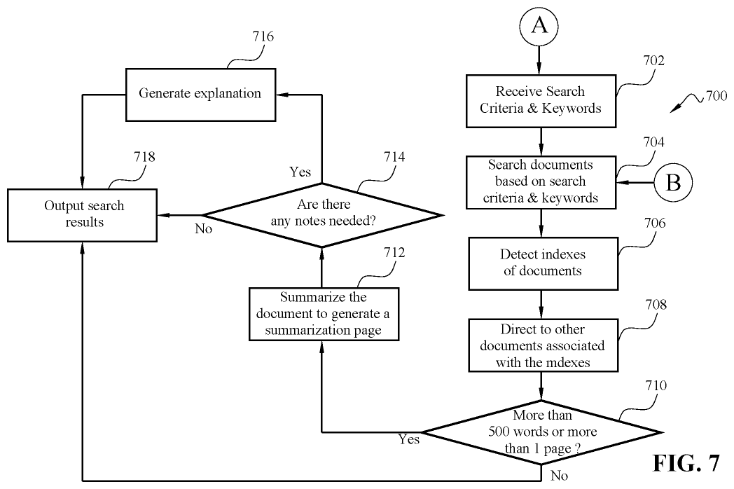

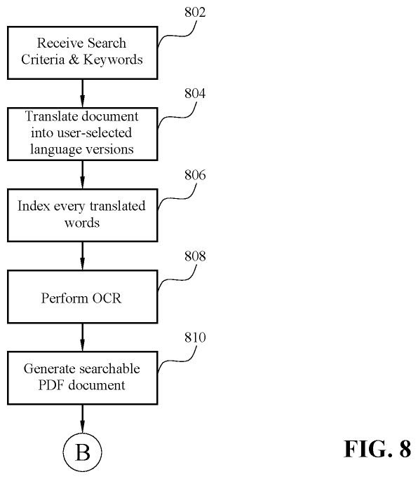

The above indexing manners are for examples only and not for limitations. Details of the indexing will be described below together with a document searching process illustrated in FIGS. 7-8.

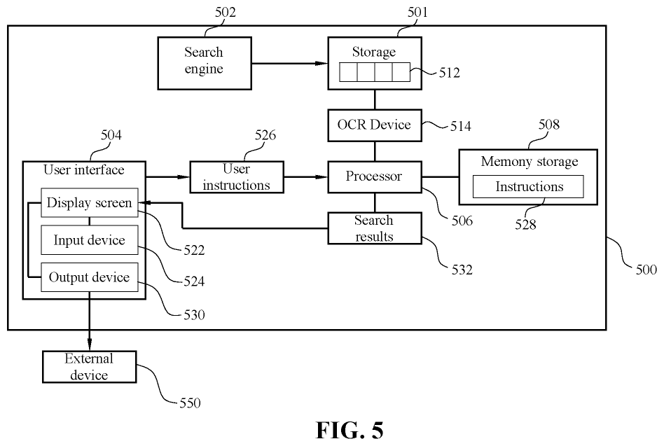

FIG. 5 illustrates a block diagram of document searching system 500 in accordance with the disclosed embodiments. Document searching system 500 is similar to document searching device 120 shown in FIG. 1 but shows more details of the disclosed embodiments. As described above, the uploaded electronic documents can be translated into different language versions based on a language selection of an administrator, but also can be translated into only user-selected language versions. OCR performance can be done during the translation when the document searching is conducted.

Document searching system 500 includes a processor 508 that interacts with a search engine 502 and a user interface 504 to search documents 512 stored in storage 510. The documents 512 may be searchable PDF documents, as those 210 of FIG. 2, which are generated by the OCR performing system 200. Alternatively, the documents 512 may be electronic documents that will be translated into user-selective languages during an OPR process.

In the former embodiment, the documents 512 are saved as searchable multi-language PDF versions, such as those 210A, 210B, . . . , 210N of FIG. 2. The translated languages are chosen by a system administrator. In this case, OCR device 514 is not needed as documents 512 have already been processed with OCR performance previously. While conducting a document search, a user enters user instructions 526 by selecting desired language versions from a list of language selections at a display screen 522 through an input device 524 at user interface 504. The user may also enter keywords and search criteria by the input device 524. The document searching system 500 further includes a processor 506 and a memory storage 508 storing instructions 528 that when executed, will cause processor 506 to communicate with search engine 502 to search the storage 510 to find any documents 512 that match with the keywords and the search criteria. The search criteria may be predetermined criteria set up by the system administrator and include a list of selections. Exemplary selections may include searching multi-language versions containing multilingual words, multidialectal words, transliterated words, synonymous words, or copyedited words that match with a single-language keyword. Preferably, the user may enable and/or disable some selections among the list.

In the latter embodiment, i.e., the documents 512 are original electronic documents, the user selects desired language versions and the search criteria through the input device 524. After the user instructions 526 are received by the processor 506, the processor 506 will first translate the documents 512 into user-selected language versions and instructs OCR device 514 to perform OCR on the user-selected language versions. As described above with reference to FIG. 2, while translating the documents 512, each word of the documents 512 and the translated versions will be indexed. The OCR device 514 may be an App saved in memory storage 508, and when executed, instructs the processor 506 to perform OCR on the user-selected language versions and to generate the user-selected language versions into searchable PDF documents. The searchable PDF documents are then saved in storage 510. Next, the search engine 502 searches the searchable PDF documents to find any documents matching with the keywords and the search criteria selected by the user.

Once matching documents are found, they will be sent to the display screen 522 at the user interface 504 as search results 532. The search results 532 may be further sent to an external device 550, such as a printing device, through an output device 530.

The document searching of the disclosed embodiments is based on the indexes embedded in the searchable PDF documents. As shown in FIG. 4, indexes 208 are associated with attributes or metadata 228 that includes, but not exclusively, multilingual words 2281, multidialectal words 2282, synonymous words 2283, transliterated words 2284, copyedited words 2285, and summarization page 2286.

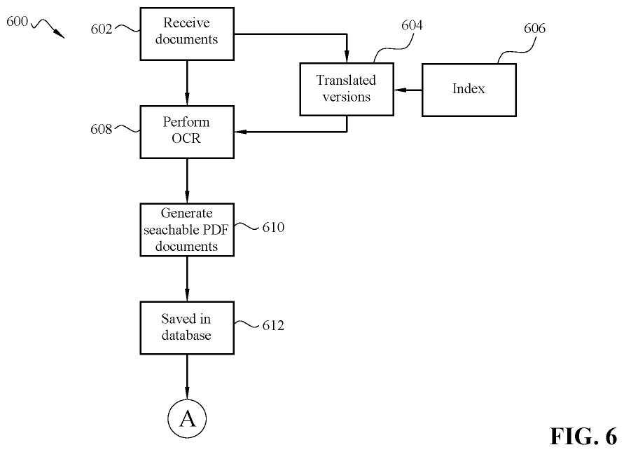

Before explaining how indexes 208 works on the document searching, FIGS. 6 and 7 illustrate flow charts of an OCR performing process and a document searching process in accordance with the disclosed embodiments.

FIG. 6 shows a flow chart 600 for a method for performing the OCR on electronic documents.

Step 602 executes by receiving documents through a network or from a storage, such as storage 112 shown in FIG. 2. Before or during an OCR performing on the received documents at step 608, step 604 executes by translating the documents into selected multi-language versions. The translated languages may be selected by a system administrator such as administrator 220 of FIG. 2, or by a user (222 in FIG. 2) when the user requests a document searching.

Step 606 executes by indexing every translated word based on their multilingual words, dialectal words, transliterated words, synonymous words, copyedited words, and their summarized version. The indexing has been described in FIG. 4.

Step 608 executes by performing OCR on the translated multi-language versions. The OCR performing detects and converts images and texts contained in the translated multi-language versions into searchable multi-language PDF documents at step 610. The OCR performing also embeds the indexes detected in the translated multi-language versions to the searchable multi-language PDF documents.

After step 610, step 612 executes by storing the searchable multi-language PDF documents in a database, which will be used for searching documents in the document searching process illustrated in FIG. 7.

FIG. 7 shows a flow chart of a method for searching documents in accordance with the disclosed embodiments. In the embodiment of FIG. 7, the OCR performance is done before the document searching starts.

Step 702 executes by receiving searching keywords and searching criteria received from a user interface, such as user interface 504 of FIG. 5.

Step 704 executes by searching documents saved in a database based on the keywords and searching criteria. As described above, the searching criteria may be a pre-determined list of criteria for selection by the user. For example, the user may select languages of the documents he prefers to search, enables selections of the multidialectal words and synonymous words of a keyword he enters, disables selections of copyedited words of the keyword he enters, and so on. The user may also select to review summarized versions of the searched documents in the search results first and then select to review a full document when necessary. In some embodiments, even though the user enters an English keyword such as “school,” he can still get a search result of a French document with a French word “école,” which means “school” in French. This feature can be done with the multidialectal indexing on the searchable multi-language PDF documents. The indexing will be explained in steps 706 and 708.

Step 706 executes by detecting indexes on a searchable multi-language PDF document, and step 708 executes by directing to other multi-language PDF document/documents associated with the indexes.

Back to FIG. 4 regarding indexes 208. To facilitate the understanding of the functions of indexes 208, the OCR performing system 200 will be incorporated here as an example.

In FIG. 4, Index 1 is associated with and will be linked to multilingual words 2281 in translated multi-language versions 204 when it is detected. Using an example of a multinational business with many users from different countries using different languages: A French user living in France uploads a 10-page French-language document containing the word “école” (which means “school” in French) to a document management system, which then performs full-document OCR in French. Currently, if another user searches document containing the word “école,” that document should be listed in the search results.

To improve search results for users that do not know French, that same document is translated and indexed in multiple languages. For example, an English user who searches for “school” should receive that French-language document among their search results, even if “school” is not anywhere in the original document but because “school” is a translation of “école.”

Index 2 is associated with and will be linked to multidialectal words in the multi-language versions 204 when it is detected. This is particularly beneficial for users that use the same language but different dialects. In this case, documents containing words not frequently used in the user's local region will have the more commonly used words indexed as well. For example, an English document containing the word “elevator” (US-English) will also be indexed for searches with the word “lift” (UK-English).

Index 3 will be directed to synonymous words in the multi-language versions 204 when it is detected. For example, if a French user searches for “école” which is also used to refer to their primary school, then they should also receive English document results containing the English word “elementary” as it refers to the primary school in US.

Index 4 is associated with transliterated words in the multi-language versions 204. According to the disclosed embodiments, in order to increase searching flexibility, users may search using transliterated words and receive translated results. For example, an English user may search for “neko” (Japanese word for cat but using English characters) and receive results containing the word “cat” translated from different languages. Similarly, a Japanese user may search for “ [symbol] ” (Japanese word for cat but using Kanji) and also receive search results for “cat” even if the actual Kanji character “ [symbol] ” appears in no documents at all.

Continuing with another Japanese example, if a user searches for “hoteru” (Japanese word for hotel but using English characters), or “>7) \” (katakana) the user should receive search results for “hotel” translated from different languages, even if the word “hoteru” is a transliterated/transcripted loan word in itself.

Index 5 will be linked to copyedited words in multi-language versions 204. Sometimes a user will search with incorrect spelling or a document contains spelling errors. In such instances, spelling errors will be indexed with the correct spelling while maintaining the original document, and spelling errors will be examined as an unintentional mistake when used as a search term. For example, if an original document contains an incorrect spelling of “school” such as “shcool”, it will still be indexed for searches of the correct spelling so that if a user searches for “school” (correct spelling), or “skool” (incorrect spelling), or “école” (translated word), or “école” (translated word but missing an accent), that user will see the original document with the spelling error among their search results.

Least but not last, index 6 will point to summarization pages of multi-language versions 204. Index 6 associates with documents containing more than a predetermined number of words (for example, 500 words) or more than a predetermined number of pages (for example, 1 page). When Index 6 is detected on a document, a processor (e.g., processor 206 of FIG. 2) will translate and summarize the document to a single paragraph. Included with the translation and summarization are all the other aspects of this system, including considerations of incorrect spelling and synonymous words. For example, a 10-page original document that contains incorrect spellings of “phlegm” in all instances of the word (e.g. misspelled as “phlem” throughout the document) will be summarized into one paragraph and be indexed for searches of “mucous” (English synonym) or “flema” (Spanish translation).

According to the disclosed embodiments, the summarization function may highlight the search term or explain why the original document is relevant to the user's search term. An exemplary summary in the search results would be like this:
estudiodecasodeflema.pdf
   This document explains how phlegm/mucous is formed, what a patient should do for self-treatment, and when a patient should consider seeing a medical professional. ¹²³⁴
      1. This is a machine-generated summary of the original document.
      2. Your original search term “phlem” did not retrieve any results but the search term “phlegm” retrieved this document.
      3. Original document translated from Spanish. Search translated “phlegm” to “flema” and found the search term in this document.
      4. Possible multiple incorrect spellings of “flema” found in this document.

Back to the document searching process 700 of FIG. 7, if the user selects to receive summarized versions for the search results, step 710 executes by determining if a searched document has more than a predetermined number of words (500 words for example,) or has more than a certain number of pages (1 page for example). If the answer is No, the process 700 goes to step 718 that outputs the searched document in the search results. If the answer is Yes, step 712 executes by summarizing the searched document to generate a summarization page.

Step 714 executes by determining if there are any notes to be added to the search results. For example, if the user enters a misspelling word “phlem” as a keyword, the document searching system 500 will search documents with closest-correct word “phlegm” or “mucous” (synonymous word of “phlegm”). Therefore, step 716 executes by adding notes about the search to the summarization page. An example of such summarization page has been shown above regarding Index 6.

If, however, the user enters correct keyword “phlegm”, the summarization page will be outputted as a search result at step 718.

Apparently, these search improvements according to the disclosed embodiment as described above increase search language fluidity and reduce the language barrier between the user and potentially relevant results. The following example illustrates how indexes 208 are used for searching documents in accordance with the disclosed embodiments.

If a word such as “hors d′oeuvre” is misspelled in an original document as “hoderve”, that document will still appear in search results for any of the following search combinations:
“entremeses”—Spanish word for hors d′oeuvre (Multilingual).
“aperitivo”—Spanish word for appetizer (Multilingual+Synonymous).
“hoderve”—user searches using same spelling mistake as what is contained in the original document (Copyedited).
“hors d'oeuvre”—user searches using correct spelling (Copyedited).
“hors doeuvre”—user searches while missing an apostrophe (Copyedited).
“appetizier”—user searches using an incorrectly spelled synonym (Copyedited+Synonymous).
“zensai”—user searches using an anglicized version of the Japanese word for appetizer (Multilingual+Transliterated).
“starter”—As “hors d′oeuvre” is a loan word used in certain contexts/scenarios (Multidialectal+Synonymous). Machine learning also understands not to provide the user results of “starter” as used in the context of engines.

These search flexibility improvements put together will be especially useful for users that are traveling or in multi-language environments that may hear the phonetic spelling of a word but is unsure of the word's correct spelling or how to type in the local alphabet. This also helps a user who may be using a device not in their native language.

In the flow chart 700 illustrated in FIG. 7, the OCR performance is done before the document searching starts. That is, the documents are translated before the user selects the languages of the searched documents. Such an embodiment may result in a situation that the users receives more results than they want. Therefore, an alternative embodiment is to translate the documents only to the languages selected by the users before the OCR is performed, and to prioritize the search results using an algorithm based on the user's web UI (user interface) language and geolocation.

FIG. 8 is a flowchart 800 illustrating a method for searching documents in accordance with the above-mentioned alternative embodiments. In FIG. 8, the documents are translated only when a selection of languages entered by a user is received.

Step 802 executes by receiving search criteria and keywords from the user. The search criteria includes searching documents with user-selected languages.

Step 804 executes by translating the documents to only user-selected languages to generate user-selected language versions.

Step 806 executes by indexing every translated word of user-selected language versions. The indexing has been described above with reference to FIG. 4 and thus, the descriptions are omitted for brevity.

Next, step 808 executes by performing OCR on the user-selected language versions. Step 810 executes by converting the user-selected language versions into searchable PDF documents.

After the OCR performance is completed, the rest of steps will be the same as steps 704-718 of FIG. 7. Therefore, step B will start at step 704 of FIG. 7.

The document management system of the disclosed embodiments provides searching documents with different combinations of index categories, thereby providing more flexibilities and efficiencies for searching documents in multiple languages and dialects. According to the disclosed embodiments, the document searching system is capable of providing a comprehensively relevant list of multilingual search results, even if the user searches using only one language.

In addition, the users may select to view the document in its original language/dialect or have it fully translated (including any same-language dialect changes; e.g. the word “elevator” being changed to “lift”) after reviewing the summarized version, if necessary.

Further, the document searching system and method are capable of deliver search results that are related to the context of the user's recent search history. For example, when an employer who works for a construction company searches for “CAT”, the system will recognize the word “CAT” is not an animal, but a brand of construction equipment and will only deliver the search results related to the brand name “CAT”.

The ability of relating the search keyword to a recent search history can be trained with an artificial intelligence training module. In addition, the artificial intelligence training module may also translate and summarize a document of which the number of words is more than a predetermined number of words, e.g., 500 words, to a single paragraph and compose explanations of the search terms.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an

### Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more content management systems coupled to a network capable of exchanging information and data. Various functions and components of the content management system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

What is claimed is:

1. A computer-implemented method for searching documents in a variety of languages, the method comprising:
translating the documents in at least one selected language to generate multi-language versions;
indexing every translated word of the multi-language versions based on predetermined criteria, wherein every translated word is embedded with an index, and there are plural types of indexes in each of the multi-language versions;
entering a keyword and searching criteria for searching;
using the keyword and the searching criteria to search the documents, wherein the searching criteria are associated with certain types of indexes of the multi-language versions;
searching related documents based on the certain type of indexes; and
if the keyword and any of the indexed translated words of the multi-language versions match, outputting the matched multi-language version as search results.

1. The computer-implemented method of claim 1, further comprising performing an optical character recognition (OCR) on the multi-language versions before searching, wherein the OCR performance generates searchable PDF documents, wherein the plural types of indexes are embedded in the searchable PDF documents, and wherein the searching is to search the searchable PDF documents.

2. The computer-implemented method of claim 1, wherein the searching criteria includes searching documents in at least one specific language, and wherein the translating is performed after the at least one specific language is selected.

4. The computer-implemented method of claim 1, wherein the plural types of indexes include indexes associated with a multilingual meaning, a multidialectal use, different character sets and phonetic adaptions, and synonymous words of every translated word of the multi-language versions.

5. The computer-implemented method of claim 1, wherein the indexing includes indexing error-spelling words in an original document and their correct-spelling words and correlating the error-spelling words and the correct-spelling words.

6. The computer-implemented method of claim 1, further comprising creating a summarized version of the document when a length thereof is longer than a predetermined number of words or pages, and saving the summarized version of the document.

7. The computer-implemented method of claim 1, wherein the searching criteria define what type of indexes to look for during searching, and the searching criteria is selectable through a user interface.

8. The computer-implemented method of claim 1, further comprising selecting a combination of search criteria, by a user, before performing the searching.

9. A computer-implemented method for searching documents saved in a variety of language, comprising:
receiving a keyword entered by a user using a first language;
receiving searching criteria including searching a document in a second-language version;
translating original documents into the first and second languages and storing a first language version, a second language versions, and the original documents in a database, wherein the first and second language versions are linked to the original documents;
indexing each translated word of the first and second language versions, wherein each translated word of the first and second language versions is embedded with an index, and there are plural types of indexes in each of the first and second language versions;
using the keyword and the searching criteria to search the documents, wherein the searching criteria are associated with certain types of indexes of the first and second language versions;
searching related documents based on the certain type of indexes; and
if the keyword and any of the indexed translated words of the first and second versions match, outputting the matched multi-language version as search results.

10. The computer-implemented method of claim 9, further comprising performing an optical character recognition (OCR) on the first and second language versions before searching, wherein the OCR performance generates searchable PDF documents, wherein the plural types of indexes are embedded in the searchable PDF documents, and wherein the searching is to search the searchable PDF documents.

11. The computer-implemented method of claim 9, wherein the plural types of indexes include indexes associated with a multilingual meaning, a multidialectal use, different character sets and phonetic adaptions, and synonymous words of every translated word of the multi-language versions.

12. The method of claim 9, wherein the indexing includes indexing error-spelling words in an original document and their correct-spelling words and correlating the error-spelling words and the correct-spelling words.

13. The method of claim 9, further comprising creating a summarized version of the original document in different languages if a length thereof is longer than a predetermined number of words or pages, and saving the summarized version of the document.

14. The method of claim 9, wherein when the retrieved document is longer than a predetermined number of words or pages, displaying the retrieved document in a summarized version.

15. The method of claim 9, wherein the searching criteria includes different searching combination that are selectable by the user.

16. A search system for searching a document in a specific language, comprising:
a user interface interacted with a user to enter instructions and select searching criteria;
a computer, including a processor, a database, and a display, wherein the database stores computer-readable instructions, that when executed, causes the processor to perform:
translating an original document into different language versions and storing the different language versions and the original documents in a database, wherein the different language versions are linked to the original documents;
indexing each translated words of the original document based on predetermined criteria, wherein each translated word of the different language versions is embedded with an index, and there are plural types of indexes in each of the first and second language versions;
performing an optical character recognition (OCR) on the different language versions to generate searchable PDF documents, wherein the searchable PDF documents includes the indexes embedded in the different language versions;
receiving a keyword entered by the user using a first language;
receiving searching instructions including search documents in a second-language version;
using the keyword and the searching instructions to search among the searchable PDF documents, wherein the searching instructions are associated with certain types of indexes;
searching related documents based on the certain type of indexes; and
if the keyword and any of the indexes of the searchable PDF documents match, outputting the matched searchable PDF documents as search results.

17. The search system of claim 16, wherein the plural types of indexes include indexes associated with a multilingual meaning, a multidialectal use, different character sets and phonetic adaptions, and synonymous words of every translated word of the multi-language versions.

18. The search system of claim 16, wherein indexing includes indexing error-spelling words in an original document and their correct-spelling words and correlating the error-spelling words and the correct-spelling words.

19. The method of claim 16, wherein when a matched searchable PDF document is longer than a predetermined number of words or pages, displaying the match searchable PDF document in a summarized version.

20. The method of claim 16, wherein the searching instruction include different combination of search criteria that are selectable by the user.
